(19) United States
(12) Patent Application Publication
(10) Pub. No.: US 2018/0240085 A1
(43) Pub. Date: Aug. 23, 2018

(54) Two-level Blockchain-based identity and transaction framework for loyalty system

(71) Applicants: Dmitry Balachov, Geneva (CH); Denis Slabinskiy, Voorburg (NL)

(72) Inventors: Dmitry Balachov, Geneva (CH); Denis Slabinskiy, Voorburg (NL)

(21) Appl. No.: 15/944,814

(22) Filed: Apr. 4, 2018

(51) Int. Cl. G06Q 20/06; G06Q 20/22; H04L 9/06

(52) U.S. Cl. CPC G06Q 20/065; G06Q 20/223; H04L 2209/56; H04L 2209/38; H04L 9/0637

(57) ABSTRACT

A system includes delegated two-level proof-of-stake blockchain that is separated into one main master cryptographic token which allows issue of subordinated loyalty cryptographic token for business (including, but no limited to operational, accounting and taxation) purposes comprising: initiating and creating of master cryptographic token, initiating a transaction to the blockchain, identification and recording of transaction in the blockchain; exchange of master cryptographic tokens between trusted entities, creation of subordinated loyalty cryptographic tokens, expiration of subordinated loyalty cryptographic token.

### FIELD OF THE INVENTION

This invention relates to an electronic system and method for verifying that a transaction and/or transactions within the multi-layer blockchain are accurate, complete, time-bound and authentic.

### BACKGROUND

The ability to accurately account for business transactions in the current blockchain systems has become more complicated task for entities at the same time as it has become more needed. Single-layer blockchain structure does not always provide a reasonable solution (due to the significant fluctuations in its price it becomes a significant problem from accounting standpoint) to accurately account for certain business transactions in accounting records and might lead to material misstatements in routine reporting for accounting and taxation purposes.

In order to secure massive transactions in the real sector through the use of cryptocurrency or any other form of monetary equivalent, as a unit of account, parallel to the national currency used in a particular market, a relatively stable exchange rate (with low volatility) of such monetary equivalent relative to the national currency or basket of major currencies used in that market is required. In the absence of a mechanism of cryptocurrency's stable fixed exchange rate to the national currency, the cryptocurrency's participants would incur additional difficulties in terms of accounting, and the need for further actions to determine the price of a transaction (accounting for cryptocurrencies in national currency units) and accounting for additional risks associated with possible fluctuations of cryptocurrencies on the national currency.

On the other hand, the use of blockchain as a system of accounting transactions and cryptocurrency as a cash equivalent in transactions has a lot of advantage. A cryptographic currency is a digital medium of exchange that enables distributed, rapid, cryptologically secure, confirmed transactions for goods and/or services with important number of advantages compared to non-cryptographic money.

It is possible to achieve the stability of the transactional cryptocurrency exchange rate through the introduction of an issuance mechanism when the transactional cryptocurrency is issued/created automatically at the time of its acquisition for the national currency.

Tok'n'Go SA of Geneva, Switzerland, provides a distributed hash two-layer blockchain infrastructure that it currently refers to as the two-layer blockchain Infrastructure (MBI). The MBI infrastructure provides a robust and scalable system for operational, accounting and taxation purposes in which two types of cryptographic tokens exist: (i) master cryptographic tokens with a potentially variable value, which are not used for accounting purposes and they are circulated on the token exchange platform and (ii) subordinated loyalty cryptographic tokens with a fixed value which are used for record-keeping purposes between trusted entities.

### BRIEF DESCRIPTION OF THE DRAWINGS

FIG. 1 is a block diagram illustrating relations between master and subordinated loyalty cryptographic tokens

FIG. 2 is a flowchart of a system of initiation, authorization, record-keeping, custody and reconciliation of master and subordinated loyalty cryptographic tokens.

FIG. 3 is a flowchart of a method to determine the necessary quantity and timeliness of subordinated loyalty cryptographic tokens

FIG. 4 is a flowchart of a method to determine the expiration criteria for subordinated loyalty cryptographic tokens

### DETAILED DESCRIPTION

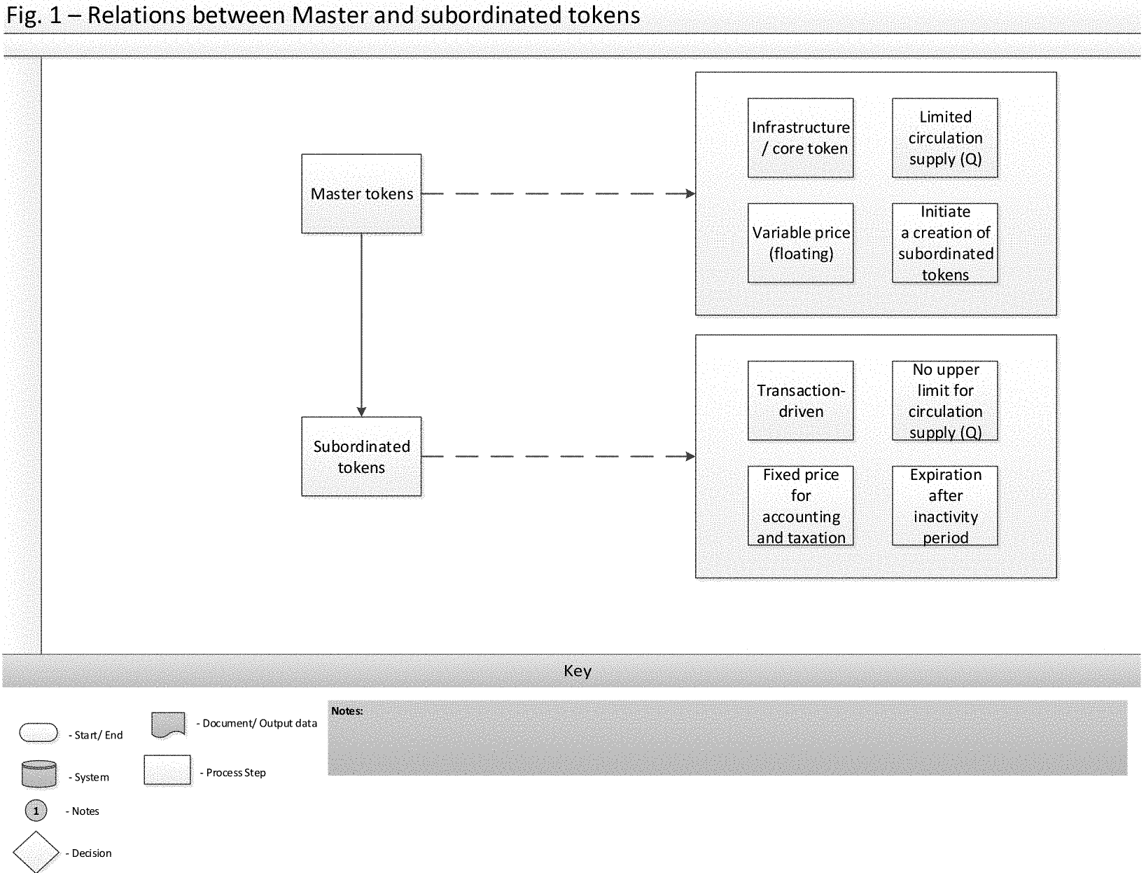

FIG. 1 is a block diagram illustrating relations between master and subordinated loyalty tokens. Master cryptographic tokens represent the first layer in the blockchain environment created for between trusted entities. The supply of master cryptographic tokens is limited to a value determined in the blockchain environment and their value is not fixed for operational and accounting purposes. Master cryptographic tokens has a function to initiate a creation of subordinated loyalty cryptographic token whenever there is a transaction occurred in the blockchain environment between trusted entities. Subordinated loyalty cryptographic tokens have a fixed accounting value per unit.

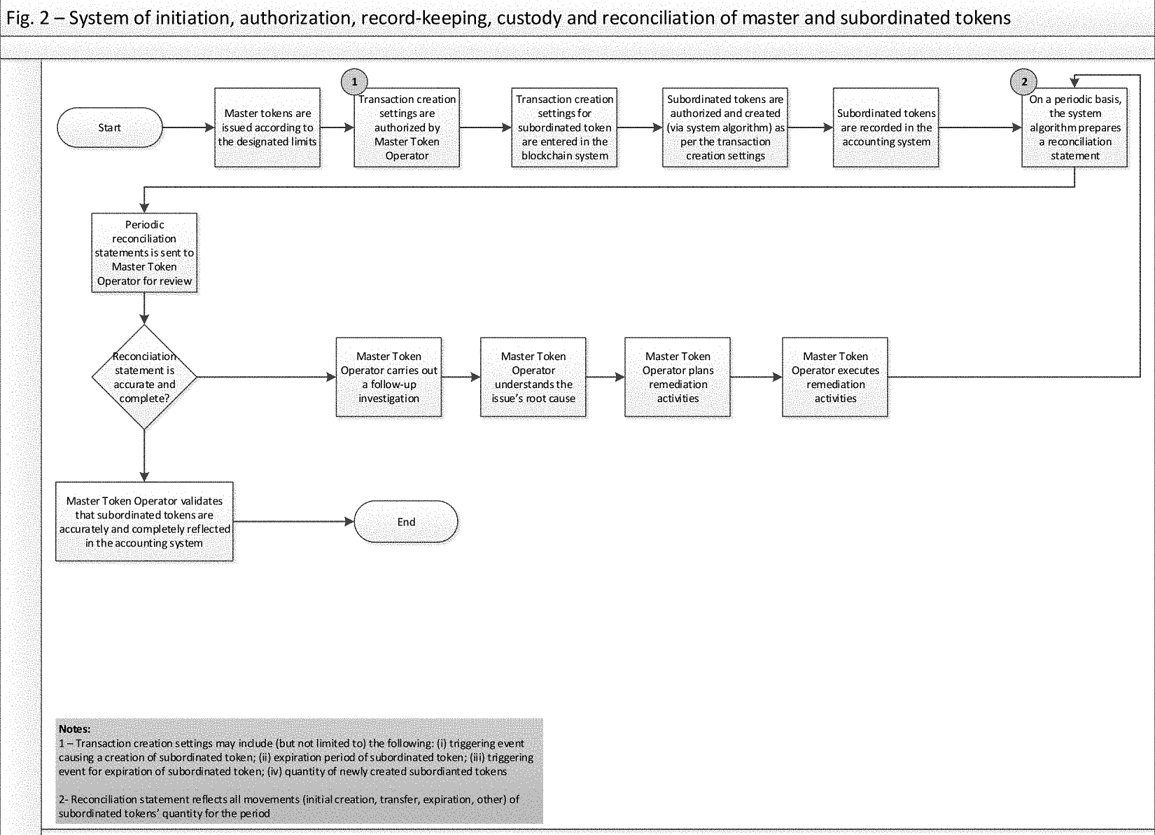

FIG. 2 is a flowchart of a system of initiation, authorization, record-keeping, custody and reconciliation of master and subordinated loyalty cryptographic tokens. Master and subordinated loyalty cryptographic tokens are based on the blockchain transaction authorization system that initiates an irrevocable record in the system ledger. There is a system functionality that enables further custody and reconciliation of master cryptographic tokens.

In summary, master cryptographic tokens generate a new structure known as subordinated loyalty cryptographic tokens according to one of more rules specified in a master cryptographic token settings. The transaction creation settings are authorized by the master cryptographic token operator and determines conditions and amount of generated subordinated loyalty cryptographic tokens.

For example, a simple subordinated loyalty cryptographic token creation can require generation of a subordinated loyalty tokens after every conditional event occurred in the blockchain system between trusted entities, such as sales between the participating entity and the customer. More complex subordinated loyalty transaction creation settings can be designed, such as settings based on a purchase type, size, composition or other characteristics of the blockchain itself or other entity or criteria. Each master cryptographic token has a probability of 1/Q to create subordinated loyalty token on the software application (e-wallet) on which such master cryptographic token is recorded.

Thus, the generation of subordinated loyalty cryptographic tokens becomes predictable in view of the transaction creation settings. Definite rules and events for triggering the creation of the subordinated loyalty token can vary. For example, the subordinated loyalty token can be triggered routinely by any sales transactions between the trusted entities and end customer causing master token owners to authorize the event and execute the subordinated loyalty token creation logic. Alternatively, the subordinated loyalty cryptographic token can be auto-approved (e.g. above a certain threshold) by the automated generation of transactions directed to master token such that it always approves the creation of subordinated loyalty tokens in response to each such generated transaction.

The reconciliation component allows to audit the blockchain to ensure the generation of subordinated loyalty cryptographic tokens complies with the token creation settings. Generation of transactions in compliance with the transaction generation settings indicates true and fair validation and execution of the subordinated loyalty cryptographic token by master token holders. However, whenever transactions do not appear in the blockchain as expected then non-compliance is identified and an exception report occurring in respect of the blockchain is detected. Such an occurrence results from master token holders not correctly validating and executing the transaction triggering the subordinated loyalty token initiation. Accordingly, the presence of potentially fraudulent or erroneously operating master token holders can be identified and mitigating or follow-up remedial action can be taken.

For reconciliation and audit trail purposes, the component has a monitoring function over the transactions occurred in a particular period in the past; as such, a detective process is in place to determine if transactions are generated in compliance with the transaction creation settings. Whenever a non-compliance is detected, the method identifies a potentially fraudulent or erroneous event and can undertake mitigating or remediation follow-up as previously described.

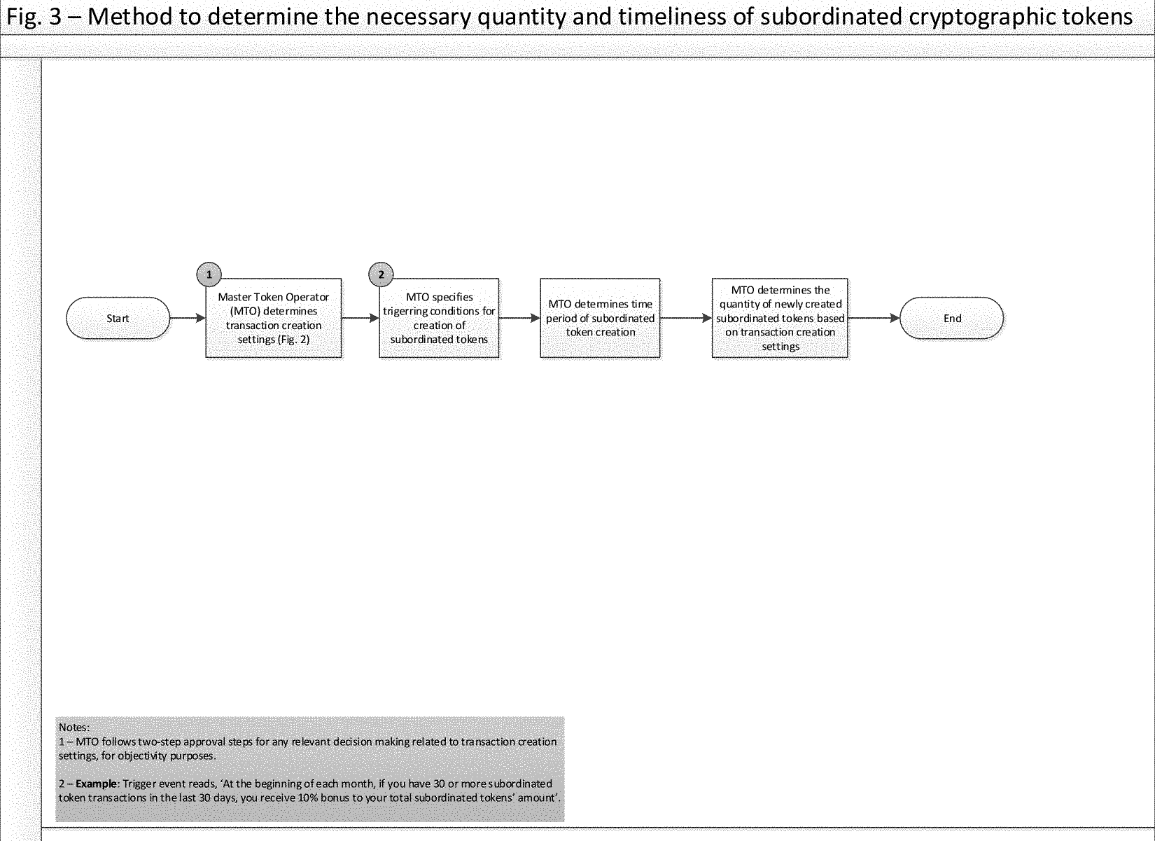

FIG. 3 is a flowchart of a method to determine the identify the necessary quantity and timeliness of subordinated loyalty cryptographic tokens. The master cryptographic token initially defines creation rules for subordinated loyalty tokens. Such creation rules represent a condition definition of when and how many subordinated loyalty tokens are to be generated and submitted to the blockchain and the rules thus determine points in time and amount of generated subordinated loyalty tokens. The points in time and amounts can be determined based on transaction data received from the master token holder executing the blockchain logic. For example the settings can be based on a time interval. The settings can be defined in terms of one or more rules that, when satisfied, lead to the generation of subordinated loyalty tokens. Such settings can be simplistic or complex and even stochastic. For example, the transaction creation settings can define that a subordinated loyalty token for a particular trusted entity is generated whenever a sales value corresponding to the size of the blockchain ends ‘ABC’ in HEX.

Effects can also create a delayed trigger event, which waits until the next time its conditions are fulfilled, then triggers usually once. (Delayed triggers that state a duration will trigger any time, within that duration, that their trigger event occurs.). Creation rules events are cumulative, and multiple instances of the same triggered event will each trigger separately.

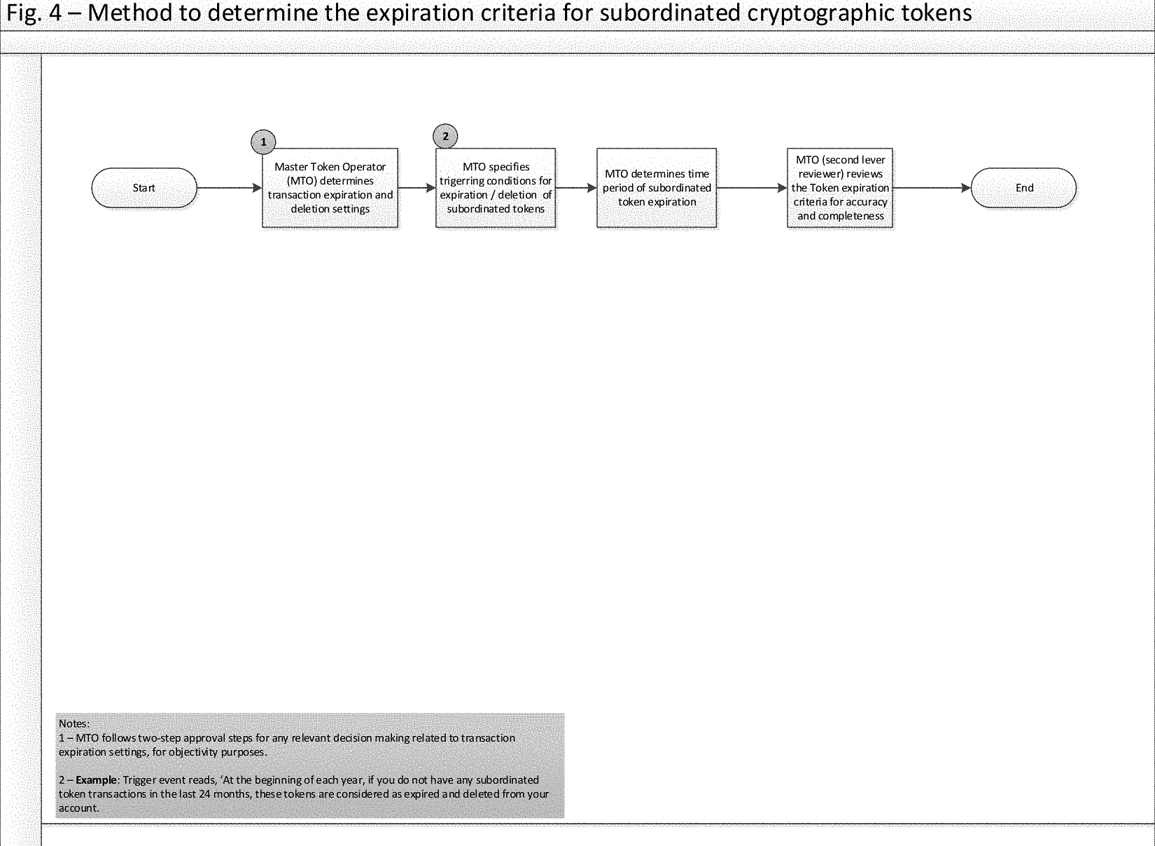

FIG. 4 is a flowchart of a method to determine the expiration criteria for subordinated loyalty cryptographic tokens triggered with respect to a blockchain in accordance with expiration of certain time period. Initially, the method defines a transaction creation settings and timestamp is recorded. After a certain period of inactivity in accordance with the pre-set transaction creation settings, a method submits a deactivation request for the amount of subordinated loyalty tokens which are not used during the certain time period (e.g. after two months of inactivity), which is transferred as a transaction to the blockchain which, when validated, results in the deactivation of a involved amount of subordinated loyalty tokens stored in the blockchain. Next, the method monitors the blockchain, and the method determines if the profile transactions stored in the blockchain are compliant with the transaction creation settings. Where compliance is determined, the deactivation is authorized and the method iterates to the deactivation recording phase. Where non-compliance is determined the method concludes detection of a potentially fraudulent or erroneous occurrence with respect to the blockchain. Optionally the method employs remediation or mitigation measures as previously described.

We claim:

1. A method for initial creation of master cryptographic tokens for the blockchain system between trusted entities

2. A method in which the master cryptographic tokens authorization, record-keeping, custody and subsequent reconciliation processes are identified and maintained in the blockchain system between trusted entities.

3. A method for subsequent creation of cryptographic loyalty tokens subordinated loyalty to the master cryptographic tokens in according with the rules specified in master cryptographic profile and initiated by a transactions in the blockchain system between trusted entities

4. A method as in claim 3, in which the cryptographic token is time-dependent.

5. The method comprising, authorization, record-keeping, custody and subsequent reconciliation of subordinated loyalty cryptographic tokens between trusted entities.

6. The method in which subordinated loyalty cryptographic tokens are expired and cancelled after the designated time limit

7. A method in which the subordinated loyalty cryptographic tokens are provided by means of software application
